(19) United States
(12) Patent Application Publication
(10) Pub. No.: US 2025/0233840 A1
(43) Pub. Date: Jul. 17, 2025

(54) SYSTEM AND METHOD FOR BULK NOTIFICATIONS REGARDING DEATH OF A PERSON

(71) Applicant: Estate Resolution Technologies (US) LLC, Wilmington, DE (US)

(72) Inventors: Jordan Jiosi, Wilmington, DE (US); Paul J. Flumano, Bradenton, FL (US)

(73) Assignee: Estate Resolution Technologies (US) LLC, Wilmington, DE (US)

(21) Appl. No.: 18/931,910

(22) Filed: Oct. 30, 2024

Related U.S. Application Data
(60) Provisional application No. 63/596,064, filed on Nov. 3, 2023.

(51) Int. Cl. H04L 51/214; G06Q 40/02; G06Q 40/06; G06Q 40/08; G06Q 50/18; H04W 4/12

(52) U.S. Cl. CPC H04L 51/214; G06Q 40/02; G06Q 40/06; G06Q 40/08; G06Q 50/186; H04W 4/12

(57) ABSTRACT

A decedent notification system includes a notifier interface and a notifier processor, coupled to the notifier interface. The decedent notification system also includes a notifier memory coupled to the notifier processor. The notifier memory is configured to include a recipient record associated with a client and including a recipient interface address. The notifier memory is also configured to include a notification instruction configured to be sent to the recipient interface address. The notifier memory is further configured to include a decedent record referencing the notification instruction. The decedent notification system also includes notifier programming in the notifier memory, wherein execution of the notifier programming by the notifier processor configures the decedent notification system to implement functions. The decedent notification system determines the client has died. The decedent notification system sends the notification instruction to the recipient interface address included in the recipient record associated with the client.

### CROSS-REFERENCE TO RELATED APPLICATIONS

This application claims the benefit of U.S. Provisional Application No. 63/596,064, filed Nov. 3, 2023, which is incorporated by reference herein in its entirety.

### FIELD OF INVENTION

The invention relates to systems and methods for determining the death of a person, and upon determination subsequently notifying parties such as governments, creditors, heirs, and beneficiaries, of that death.

### BACKGROUND

The proliferation of digital solutions for record-keeping and financial instruments held in diversified investment portfolios, bank accounts, trusts, ownership structures, and personal accounts have allowed users control over their assets and information. However, this proliferation can complicate a person's estate following death. Historically, upon one's death, a person's financial assets, they would likely be located at a single bank (checking and savings account, mortgages or assets kept in a safe deposit box) and may be at a brokerage for stocks. The executor of that decedent's estate would be able to make one or two physical visits, such as to the bank/brokerage and the courthouse, to acquire all of the decedent's financial records.

Today, however, a person may have dozens of bank accounts, investment portfolios, and real properties. If social media or web service accounts are added to the tally, a person may have hundreds of accounts requiring access by the executor. Further, by design, these accounts may all be intentionally decentralized, in order to diversify assets, as well as management of those assets, and visibility by third-parties into those assets. Thus, the task of an executor of a decedent's estate has in many instances become incredibly more complicated before the proliferation of digital solutions. In carrying out their functions, an executor typically must (1) locate and identify all of the accounts of the decedent, which may be difficult considering that some accounts may be deliberately hidden; and (2) contact each of those institutions, in the manner in which those institutions elect to be contacted, to inform the institution that their client has died. This process often needs to be performed relatively quickly, because in some cases such as life insurance policies or retirement accounts, the institution itself must identify the beneficiaries in order to disburse or transfer funds, funds which may be needed to maintain the remainder of the estate by paying levies or taxes. Additionally, different institutions take different amounts of time to transfer or retitle property, and low-priority assets may ultimately take the most time to effect transfer, which can delay processing the estate.

The executor must also notify next-of-kin, creditors, and beneficiaries, in accordance with both the law and the wishes of the decedent. It is possible that the decedent may not want all of their survivors provided the same information regarding the assets of the estate.

Finally, the decedent may want certain personal accounts, such as social media accounts, email accounts, or small expense accounts such as web domain renewals, turned over to particular next-of-kin to manage. These type of requests may not generally be considered within the scope of the tasks which an executor is expected to manage. Further, the relevant log-in information, such as usernames, passwords, and secondary authentications, may be outdated (not updated with changes that took place subsequently) from when that information was provided to the executor during the decedent's life.

This proliferation of accounts, and therefore tasks, which an executor of a decedent's estate may be expected to execute, has made the role of the executor substantially more difficult in recent years with respect to the collection, aggregation, and notification of institutions at which a decedent was a client, as well as appropriately transferring the non-financial information to next-of-kin.

### SUMMARY OF THE INVENTION

Hence, there is room for improvement in the systems and methods for determining the death of a person, and upon determination subsequently notifying parties such as governments, creditors, heirs, and beneficiaries, of that death. The systems and methods of the present invention allow for the creation of a repository of clients and institutions, where the clients enter information relevant to accessing or transferring their client accounts at their institutions to a third-party, such as a beneficiary or an executor. The information entered may also include instructions to the institution, or may simply identify the account at the institution. Later, upon the passing of the client, the death of the client is verified. Verification may come in several forms, such as the notifier system personnel verifying a death certificate, a pre-approved executor attesting to the death of the client, or an automated report from a death database containing identifying information (e.g., social security numbers) of decedents. Once verified, the notifier system personnel, which may be technicians who operate the all companies deceased notification system, or the executor of the client's estate, may review and then send the previously-prepared notifications to all of the institutions in the format and structure previously set by the client. Or, an automated system may automatically transmit the notifications upon the verification of the client's death.

This system minimizes the time and effort of the executor in performing all of this work after the death of the client, because the client, with or without assistance, sets up all or many of the notifications while they are alive. After their death the executor or the all companies deceased notification system has to verify that death and subsequently send out the pre-death-prepared notifications in an automated manner.

In one exemplary embodiment, there is provided an all companies deceased notification system including a notifier interface, a notifier processor coupled to the notifier interface, and a notifier memory coupled to the notifier processor. The notifier memory is configured to include a recipient record, a notification instruction, and a decedent record. The recipient record is associated with a client, and includes a recipient interface address. The notification instruction is configured to be sent to the recipient interface address. The decedent record references the notification instruction. The all companies deceased notification system also includes notifier programming in the notifier memory. Execution of the notifier programming by the notifier processor configures the all companies deceased notification system to implement functions. The all companies deceased notification system determines the client has died. The decent notification system sends the notification instruction to the recipient interface address included in the recipient record associated with the client.

In some examples, the all companies deceased notification system can further include a recipient interface, wherein the sent notification instruction is displayed on the recipient interface. The all companies deceased notification system can include a notifier network interface, coupled to the notifier interface and configured to communicate over a network. The all companies deceased notification system can further include a recipient network interface, coupled to the recipient interface and configured to communicate over the network, wherein the notification instruction sent to the recipient interface address is sent from the notifier network interface to the recipient network interface via the network. The recipient interface can be configured to receive digital signals and analog signals, and the notification instruction sent to the recipient interface address from the notifier network interface can be sent only as a digital signal. Alternatively or additionally, the recipient interface can be configured to receive digital signals in a non-human-readable format, and to receive analog signals or digital signals in a human-readable format, and the notification instruction sent to the recipient interface address from the notifier network interface can be sent only as a digital signal in a non-human readable format.

In some examples, the function to determine the client has died can further include comparing death certificate information from a death certificate to client information associated with the client. Alternatively or additionally, the function to determine the client has died can further include comparing a recorded identifier in an identifier death database to a client identifier associated with the client. The identifier death database can be included within the notifier memory.

In some examples, the all companies deceased notification system further includes a client interface, a client processor coupled to the client interface, a client memory coupled to the client processor, and client programming in the client memory. Execution of the client programming by the client processor configures the all companies deceased notification system to implement functions, including the all companies deceased notification system creating or modifying the notification instruction.

In some examples, the notification instruction includes credentials associated with the client at a recipient associated with the recipient interface address. the recipient interface address can be associated with a recipient. The client can be associated with a client account held by the recipient. The notification instruction can include a credentialing prerogative, the credentialing prerogative instructing the recipient to associate the client account to a third-party credential.

In another exemplary embodiment, there is provided a all companies deceased notification system including a notifier interface, a notifier processor coupled to the notifier interface, and a notifier memory coupled to the notifier processor. The notifier memory is configured to include a first recipient record of a plurality of recipient records, a first notification instruction of a plurality of notification instructions, a second recipient record of the plurality of recipient records, a second notification instruction of the plurality of notification instructions, and a decedent record. The first recipient record is associated with a client and includes a first recipient interface address of a plurality of recipient addresses. The first notification instruction is configured to be sent to the first recipient interface address. The second recipient record is associated with the client and includes a second recipient interface address of the plurality of recipient addresses. The second notification instruction is configured to be sent to the second recipient interface address. The decedent record is configured to reference the plurality of notification instructions. The all companies deceased notification system also includes notifier programming in the notifier memory. Execution of the notifier programming by the notifier processor configures the all companies deceased notification system to implement functions. The all companies deceased notification system determines the client has died. The all companies deceased notification system sends the plurality of notification instructions to the plurality of recipient interface addresses included in the plurality of recipient records associated with the client.

In some examples, the plurality of notification instructions can be all sent to the plurality of recipient interface addresses included in the plurality of recipient records associated with the client in response to a single physical interaction at the notifier interface. Alternatively or additionally, the plurality of notification instructions can all be sent to the plurality of recipient interface addresses included in the plurality of recipient records associated with the client in response to the determination that the client has died and zero physical interactions at the notifier interface.

In yet another exemplary embodiment, there is provided a method including creating a decedent record, the decedent record associated with a client. The method also includes creating a recipient record, the recipient record referencing the decedent record and including a recipient interface address. The method further includes creating a notification instruction, the notification instruction referencing the recipient record and configured to be sent to the recipient interface address. The method additionally includes determining the client has died. Further, the method includes sending the notification instruction to the recipient interface address included in the recipient record associated with the client.

Determining the client has died further can include comparing death certificate information from a death certificate to client information associated with the client. Alternatively or additionally, determining the client has died can further include comparing a recorded identifier in an identifier death database to a client identifier associated with the client.

The method can further include sending a plurality of notification instructions to a plurality of recipient interface addresses included in a plurality of recipient records associated with the client. The plurality of notification instructions to the plurality of recipient interface addresses included in the plurality of recipient records associated with the client can all be sent in response to a single physical interaction. Alternatively or additionally, the plurality of notification instructions to the plurality of recipient interface addresses included in the plurality of recipient records associated with the client can all be sent in response to the determination that the client has died.

### BRIEF DESCRIPTION OF THE DRAWINGS

The invention is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to the elements collectively or to a non-specific one or more of the elements, the small letter designation may be dropped. According to common practice, the various features of the drawings are not drawn to scale unless otherwise indicated. To the contrary, the dimensions of the various features may be expanded or reduced for clarity. Embodiments of inventions will now be described, strictly by way of example and not limitation, with reference to the accompanying figures, in which:

FIG. 1 is a system diagram of all companies deceased notification system including client device, two recipient devices, and notifier device;

FIG. 2 is a flowchart depicting the all companies deceased notification process; and

FIGS. 3A and 3B are flowcharts depicting a detailed implementation of a portion of the all companies deceased notification process.

### DETAILED DESCRIPTION OF THE DRAWINGS

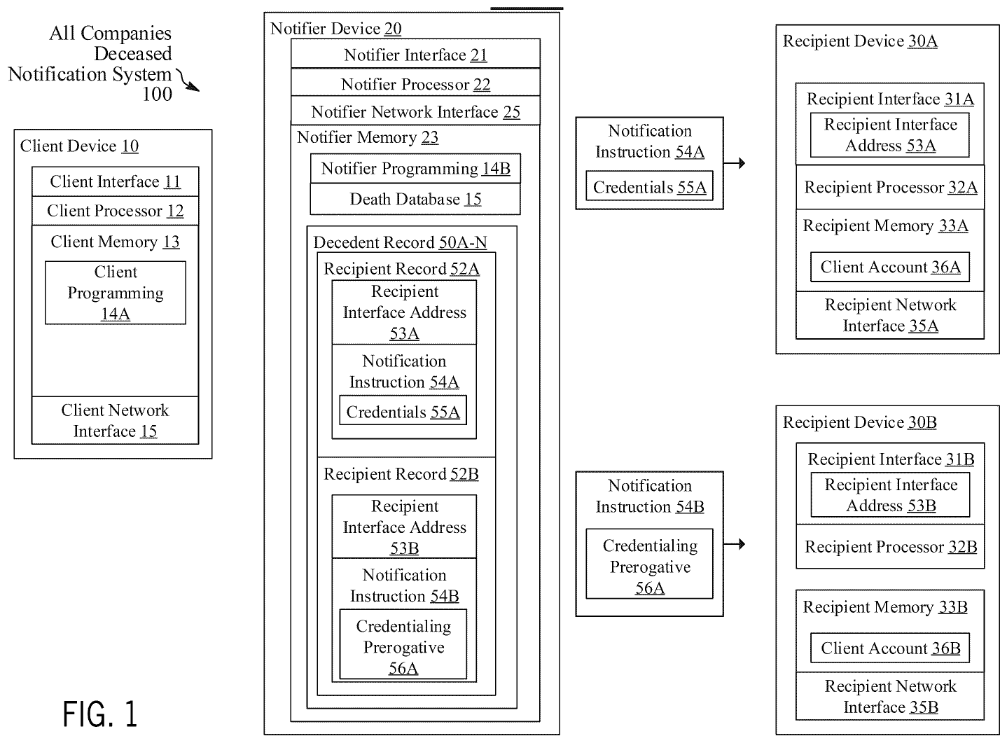

FIG. 1 is a system diagram of a all companies deceased notification system 100 including client device 10, two recipient devices 30A-B, and notifier device 20. Client device 10 may exist separately from notifier device 20, or client device 10 be co-located with or embedded within notifier device 20.

Client device 10 includes client interface 11, by which a client may create and populate decedent records 50A-N. decedent record 50A is a collection of instructions for some entity which survives the client, to be executed after the death of the client. The instructions can be procedural, such as directing an automated clearing house (ACH) transfer from one bank account to another bank account, or more interpretive, such as an instruction to “satisfy” or “make whole” a third-party, with the recipient or some other party presumed to interpret what “satisfy” or “make whole” may mean in context after the death of the client. The instructions can be structural, for example comporting with the ACH file format established by the National Automated Clearing House Association (NACHA), or free-form, such as human-readable or prose instructions to move titled property from entity A to entity B. The instructions are packaged as notification instruction 54A.

Notification instructions 54A are stored in recipient record 52A, which is associated or stored within decedent record 50A. Recipient record 52A also stores recipient interface address 53A, and represents a particular set of instructions as well as where to send those instructions.

Recipient interface address 53A includes any addressable format. In this example, recipient interface address 53A is a target email address or an IP address and receiving port of recipient device 30A. Notifier device 20 uses the target email address or IP address to digitally send notification instruction 53A to the recipient device 30A. However, recipient interface address 53A could represent a physical mailing address, and notifier device 20 could include or be coupled to an automated mailer system: in such examples, notification instruction 53A may be printed on physical paper, packaged by the automated mailer system, and delivered to the recipient device 30A by a parcel company, postal service, or courier at the physical mailing address stored as recipient interface address 53A. Recipient interface address 53A may represent a phone number, and notifier device 20 may fax or read the contents over a telephone connection to recipient device 30A at recipient interface address 53A.

Recipient interface address 53A and notification instruction 54A preferably are of a format and to an address that the recipient device 30A expects formatted communications. For example, assume recipient device 30A expects an email, with the email title including the client's full name; the email body including an ordered list of tuples including comma-separated source bank account numbers, target bank account number, and dollar values; as well as a death certificate and power of attorney forms attached as two separate portable document format (PDF) documents in order to facilitate balance transfer. In that example, notification instruction 54A should take that form and include those instructions before being emailed to recipient interface address 53A in order to allow recipient device 30A to effectuate those balance transfers.

Notifier device 20 may modify the format of notification instruction 54A from the format entered by the client to facilitate efficient storage or to meet the structure requirements placed by the recipient device 30A for receiving instructions at the recipient interface address 53A. The format of notification instruction 54A may conform with legal requirements, and additionally in such cases may eschew the format request by the recipient device 30A. For example, if cancelling a subscription service purportedly requires a phone call according to recipient device 30A, but law permits the cancellation of subscription services on behalf of a decedent by letter, then notification instruction 54A may be sent as a letter rather than as a phone call to recipient device 30A.

Notification instruction 54A may include credentials 55A. Credentials 55A include any type of information used to prove rights to request service from recipient device 30A. Credentials 55A can include (in both a physical or digital format) usernames, passwords, multi-factor authentication codes, powers of attorney, notarized documents, government-issued documents such as birth certificates and passports, links to third-party-held documents, such as a link to a government-hosted document, account numbers, photographs, signatures, handwriting samples, court orders, warrants, affidavits, and other such proofs.

Together or separate from credentials 55A, credentialing prerogative 56A may also be sent. Credentialing prerogative 56A is a type or subset of notification instruction 54B, whereby the credentials of a third-party are to be given the same weight of control as credentials 55A of the client. For example, notification instruction 54B directing recipient device 30B to add the executor of the client's estate as an authorized user includes credentialing prerogative 56A directing recipient device 30B to accept the credentials of the executor as they would accept credentials 55A of the client.

When credentialing prerogative 56A is used, the third-party who is to be credentialed may be sent their own notification instruction, directing that third-party how to utilize their control in accordance with the desires of the client. For example, rather than directing a bank to give $20 to a local church every Sunday for ten years (which the bank may be unwilling to facilitate, preferring to effect a one-time transfer to the church), the client may instead direct the bank with credentialing prerogative 56A to allow a friend withdrawal privileges from a bank account of the client containing approximately $10,000. Then, separately, the client can direct that friend to withdraw that cash as needed to make the requested periodic donations on the weekly basis.

Client processor 12 executes software functions described in client programming 14A stored in client memory 13, along with other instructions to facilitate operation of client device 10. Some of the software functions can include sending messages utilizing the client network interface 15 to the notifier device 20 if the notifier device 20 is not co-located with the client device 10, either directly or over a network. Client device 10 can be a personal computer or mobile device: in such and similar examples, client processor 12 is the processor of the personal computer or mobile device, client memory 13 is the memory or a sub-set of the memory of the personal computer or mobile device, client interface 11 is the interface of the personal computer or mobile device, and client network interface 15 is the network interface of the personal computer or mobile device.

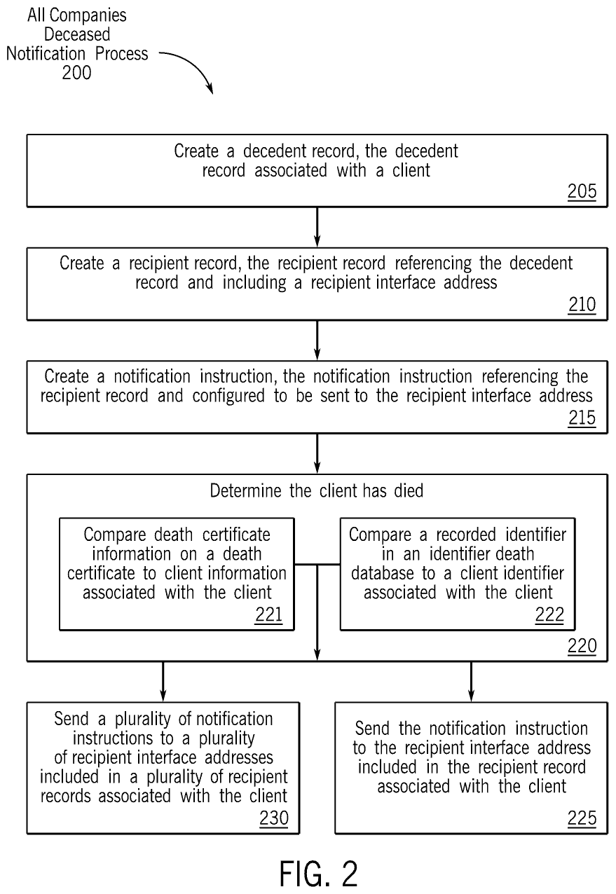

Programming 14A-B collectively describes the functions performed to facilitate all companies deceased notification system 100 and all companies deceased notification process 200 (see FIG. 2) Depending upon the implementation, certain components of all companies deceased notification system 100 can perform certain functions. For example, the client programming 14A can modify the data within decedent record 50A, adding additional notification instructions 54A-B, but the notifier device can also modify decedent records 50A-N.

Recipient devices 30A-B includes recipient interfaces 31A, at which personnel at a recipient institution may view and process notification instructions 54A-B. Recipient devices 30A-B include recipient interface 31A-B by which personnel at a recipient institution can interact with the all companies deceased notification system 100: in some examples, the recipient institution has an existing relationship with all companies deceased notification system 100. In those examples, the recipient institution can configure both recipient interface address 53A and the format of notification instruction 54A to facilitate execution of notification instruction 54A. For example, if recipient device 30A is updated to listen on a different network port for notification instructions, the recipient institution can configure recipient interface address 53A to use that updated port address without input from the client or client device 10. Additionally, if the recipient institution decides that they require the death certificate of the client to be directly furnished from the state, they can modify the requirements of notification instruction 54A to provide a link to that state-furnished death certificate, rather than to provide a copy of the death certificate. In such circumstances, the client while alive may be able to update notification instructions 54A to comport with the updated requirements, or the executor or personnel using notifier device 20 may update notification instruction 54A after the death of the client to comport with the updated requirements.

Recipient processors 32A-B can execute software functions to facilitate operation of the invitee devices 30A-B, such as when recipient device 30A-N is a networked computing device. Recipient devices 30A-B can be a personal computer or mobile device: in such and similar examples, recipient processor 31A-B is the processor of the personal computer or mobile device, recipient memory 33A-B is the memory or a sub-set of the memory of the personal computer or mobile device, recipient interface 31A-B is the interface of the personal computer or mobile device, and recipient network interface 35A-B is the network interface of the personal computer or mobile device. Recipient memory 33A-B can also contain client account 36A-B, which can be modified based on notification instructions 54A-B, either immediately, selectively based on the validity of credentials 55A, or later by a third-party with credentials after a valid credentialing prerogative 56A is executed.

However, as recipient device 30A-B is any device capable of receiving notification instructions 54A-B at recipient interface addresses 53A-B, recipient device 30A-B could be a physical mailbox, a telephone voicemail machine, fax machine, or the desk of secretarial or administrative staff, or anywhere at an institution capable of being furnished with a parcel. Additionally, while an institution can be a bank or a courthouse, an institution can also be a law firm, hospital, doctor's office, landscaping company, veterinarian, or other individual persons whom the client has instructions for upon their death, or wishes to inform of their death. The instructions may or may not be legally binding or enforceable, and the client may select persons to instruct to perform tasks whom their estate does not have leverage or enforceable control over, as opposed to an institution compelled to perform tasks in accordance with the instructions. The instructions may be contradictory (among a particular notification instruction 54A or across multiple notification instructions 54A-B), instruct illegal behavior or outcomes, or instruct impossible behavior or outcomes.

Notifier device 20 manages the time-shifted messaging between client device 10 and recipient devices 30A-B, and stores decedent, recipient, and instruction states in order to facilitate all companies deceased notification system 100. For example, though not shown notifier device 20 can log acknowledgements, confirmations, or rejections sent back from recipient devices 30A-B in response to notification instruction 54A-B, and can allow the executor to review these logged messages to ensure the estate of the client is being undertaken correctly. Notifier processor 32 executes software functions described in notifier programming 14B stored in notifier memory 33, along with other instructions to facilitate operation of the notifier device 20. Some of the software functions include sending messages utilizing the notifier network interface 25 to client device 10 and recipient devices 30A-B, either directly or over a network, and either immediately or time-shifted to after the death of the client.

Notifier device 20 can include notifier interface 21, for personnel running notifier device 20 to operate notifier device 20, or for executors to review decedent records 50A-N, update or add recipient records 52A-B, send notification instructions 54A-B, review sent or unsent notification instructions 54A-B, and review any responses from recipients.

Notifier memory 23 stores several objects to facilitate all companies deceased notification system 100. The notifier memory 23 can include death database 15, which stores correspondences between clients and their death: this information may associate with a user ID, and can include email addresses, phone numbers, IP addresses, MAC addresses, public and private keys, physical mailing addresses, driver's license numbers, social security numbers, passport numbers or copies of passports: any information used to verify the identity of the client to notifier device 20 or recipient devices 30A-B, or to verify the death of that client to notifier device 20 or recipient devices 30A-B, can be included in death database 15.

Decedent records 50A-N, described above, are each a record for a client or person who either is alive and has instructions for recipients after their death, or is dead and has instructions for recipients which have not yet been sent, has instructions not yet fully executed, or has a non-closed estate. Decedent records 50A-N for closed estates may be archived anywhere. Each recipient record 52A-B in decedent record 50A represents a recipient or institution for which the client has instructions upon their death. The instruction can be as simple as a pure notification of death, especially where the recipient separately has instructions. For example, an investment account having beneficiaries designated at the client account 36A-B at the holding investment bank: the investment bank needs only proof of death to perform the instructions they had been given during the life of the client by the client to transfer funds, assets, or accounts to designated beneficiaries. In such examples, any instruction can be functionally indicating “I have died, [do as previously instructed in this circumstance]”

The instructions for the recipients are stored as notification instructions 54A-B, associated in the recipient records 52A-B, along with recipient interface address 53A-B in order to send the instruction to the proper location or interface for the recipient to receive the instruction and process the instruction. Those instructions may include credentials 55A, which provide evidence of the authority the notification instruction 54A wields in providing its instruction, and may include credentialing prerogative 56A which provides instructions regarding who to accept instructions from, and what credentials will be acceptable for the recipient to accept as proof of authority of a person asserting to be the third-party empowered to make decisions regarding client account 36B.

Notifier device 20 facilitates the transmission of notification instructions 54A-B in several ways. First, as notification instructions 54A-B are set by the client at client device 10, and may be structurally maintained by the recipients at recipient device 30A-B to ensure proper formatting and contents are included, once the client has died the executor is empowered to review all of the instructions, add or update any missing documentation, and send all notification instruction 54A-B with a single click or button press: if several hundred notifications need to be sent, the executor can send all of those notifications to their respective recipients with a single action. Then, the executor can review responses either at notifier device 20 or elsewhere, and follow-up with intended recipients who may not have received or properly executed the instructions included in their respective notification instruction 54A-B. The executor may also add additional recipient records to decedent record 50A, in order to send and track instructions that the client desired or the client's estate requires, but were not entered by the client at client device 10 for any reason.

In another example, once a client dies, proof of death may be obtained without the input of the executor, such as by regular updates to death database. In such an example, the notifier device 20 can be configured, either by the client or the executor, to automatically send notification instructions 54A-B without any further input. In such an example, it is conceivable that the executor themselves could be a recipient of a notification instruction, one which reminds (or informs) the recipient that the client has died, and reminds (or informs) the recipient that they are the selected executor. Such a notification instruction may also include credentials or a credentialing prerogative allowing the (possibly newly-minted) executor access to notifier device 20, or access to decedent record 50A of the client, in order to correct malformed recipient records (recipient records with incorrect recipient interface address or incomplete notification instructions) or observe status updates from recipients regarding notification instructions 54A-B.

Processors 12, 22, 32A-B serve to perform various operations, for example, in accordance with instructions or programming executable by processors 12, 22, 32A-B. Although processors 12, 22, 32A-B may be configured by use of hardwired logic, typical processors 12, 22, 32A-B may be general processing circuits configured by execution of programming. Processors 12, 22, 32A-B includes elements structured and arranged to perform one or more processing functions, typically various data processing functions. Although discrete logic components may be used, the examples utilize components forming a programmable CPU. Processors 12, 22, 32A-B, for example, may include one or more integrated circuit (IC) chips incorporating the electronic elements to perform the functions of the CPU. Processors 12, 22, 32A-C, for example, may be based on any known or available microprocessor architecture, such as a Reduced Instruction Set Computing (RISC) using an ARM architecture, commonly used in mobile devices and other portable electronic devices. Of course, other processor circuitry may be used to form processors 12, 22, 32A-B.

Interfaces 11, 21, 31A-C for performing the methods as described may be, for example and without limitation, a touchscreen device where invitation instructions are inputted via a user interface application through manipulation or gestures on a touch screen. For output purposes, the touch screen of the user interface includes a display screen, such as a liquid crystal display (LCD) or light emitting diode (LED) screen or the like. A printer may also be constituted as a part of the interfaces 31A-B for the purpose of printing notification instruction 54A-B after a successful transfer. For input purposes, a touch screen includes a plurality of touch sensors.

In other embodiments, a keypad may be implemented in hardware as a physical keyboard of the user interface, and keys may correspond to hardware keys of such a keyboard. Alternatively, some or all of the keys (and keyboard) may be implemented as “soft keys” of a virtual keyboard graphically represented in an appropriate arrangement via touch screen. The soft keys presented on the touch screen may allow the user to invoke the same user interface functions as with the physical hardware keys. The user interface is not limited to any particular hardware and/or software for facilitating user input, however. The user interface may have a graphical interface, such as a screen, and tactile interfaces, like a keyboard or mouse. It may also have a command line interface that allows for text input commands. The user interface may also have a port to accept a connection from an electronic device containing a decedent file containing one or more decedent records 50A-N with one or more respective recipient records 52A-B.

The instructions, programming, or application(s) may be software or firmware used to implement any other device functions associated with devices 10, 20, 30A-B. Program aspects of the technology may be thought of as “products” or “articles of manufacture” typically in the form of executable code or process instructions and/or associated data that is stored on or embodied in a type of machine or processor readable medium (e.g., transitory or non-transitory), such as a memory of a computer used to download or otherwise install such programming into devices 10, 30A-C and server 20, or a transportable storage device or a communications medium for carrying program for installation in devices 10, 20, 30A-B. Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

The personal computers, mobile devices, and servers described throughout the specification include but are not limited to processors 12, 22, and 32A-B (e.g. CPU) for performing the decent notification system 100 functions, memory 13, 23, and 33A-B for storing data and programming instructions for supporting the operation of processors 12, 22, and 32A-B, and any transceivers (e.g. wired, wireless, Bluetooth, WiFi, etc.) in network interface 15, 25, 35A-B for communication between devices.

Therefore, FIG. 1 depicts a all companies deceased notification system 100 or decedent notification system including a notifier interface 21, a notifier processor 22 coupled to the notifier interface 21, and a notifier memory 23 coupled to the notifier processor 22. The notifier memory 23 is configured to include a recipient record 52A, a notification instruction 54A, and a decedent record 50A. The recipient record 52A is associated with a client, and includes a recipient interface address 53A. The notification instruction 54A is configured to be sent to the recipient interface address 53A. The decedent record 50A references the notification instruction 54A. The all companies deceased notification system 100 also includes notifier programming 14B in the notifier memory 23. Execution of the notifier programming 14B by the notifier processor 21 configures the all companies deceased notification system 100 to implement functions. The all companies deceased notification system 100 determines the client has died. The decent notification system 100 sends the notification instruction 54A to the recipient interface address 53A included in the recipient record 52A associated with the client.

In some examples, the recipient device is unknown at the time of sending notification instruction 54A, and may be of any structure: for examples, the interior mailroom of a courthouse maintaining real property records may not include any digital or electrical structure whatsoever, and the processing mechanisms may be byzantine or unknowable to the public: in those examples, notification instruction 54A can take the form of a physical mailed letter, sent to recipient interface address 53A, or the mailing address of the courthouse, with no concern for the inner workings of the recipient or courthouse.

In some examples, the all companies deceased notification system 100 can further include a recipient interface 31A, wherein the sent notification instruction 54A is displayed on the recipient interface. The all companies deceased notification system 100 can include a notifier network interface 25, coupled to the notifier interface 21 and configured to communicate over a network. The all companies deceased notification system 100 can further include a recipient network interface 35A, coupled to the recipient interface 31A and configured to communicate over the network, wherein the notification instruction 54A sent to the recipient interface address 53A is sent from the notifier network interface 25 to the recipient network interface 35A via the network. The recipient network interface 35A can be co-located with the recipient interface 31A. The recipient network interface 35A and recipient interface 31A are components which collectively allow the receipt of notification instruction 54A, and permit the proper entity (personnel or computing device) to access notification instruction 54A and execute the instruction if instructions are included. The recipient interface 31A or recipient network interface 35A can be configured to receive digital signals and analog signals, and the notification instruction 54A sent to the recipient interface address 53A from the notifier network interface 25 can be sent only as a digital signal. Alternatively or additionally, the recipient interface 31A or recipient network interface 35A can be configured to receive digital signals in a non-human-readable format, and to receive analog signals or digital signals in a human-readable format, and the notification instruction sent to the recipient interface address from the notifier network interface can be sent only as a digital signal in a non-human readable format. In scenarios where recipient device 30A is a machine capable of self-executing notification instruction 54A, or receiving notification instruction 54A without human intervention, notification instruction 54A may not be human-readable as transmitted.

In some examples, the function to determine the client has died can further include comparing death certificate information from a death certificate to client information associated with the client. Alternatively or additionally, the function to determine the client has died can further include comparing a recorded identifier in an identifier death database 15 to a client identifier associated with the client. The identifier death database can be included within the notifier memory 23.

In some examples, the all companies deceased notification system 100 further includes a client interface 11, a client processor 12 coupled to the client interface 11, a client memory 13 coupled to the client processor 12, and client programming 14A in the client memory 13. Execution of the client programming 14A by the client processor 12 configures the all companies deceased notification system 100 to implement functions, including the all companies deceased notification system 100 creating or modifying the notification instruction 54A. In other examples, the client does not necessarily have particularized access to the notifier device 20, and either directly updates records 50A, 52A-B, on the notifier device 20, or their executor or personnel of the notifier device 20 update records 50A, 52A-B in accordance with the wishes of the client.

In some examples, the notification instruction 100 includes credentials 55A associated with the client at a recipient associated with the recipient interface address 53A. The recipient interface address 53A can be associated with a recipient. The client can be associated with a client account 36A held by the recipient. The notification instruction 54B can include a credentialing prerogative 56A, the credentialing prerogative 56A instructing the recipient to associate the client account to a third-party credential.

FIG. 1 also depicts a all companies deceased notification system 100 including a notifier interface 21, a notifier processor 22 coupled to the notifier interface 21, and a notifier memory 23 coupled to the notifier processor 21. The notifier memory 23 is configured to include a first recipient record 52A of a plurality of recipient records 52A-B, a first notification instruction 54A of a plurality of notification instructions 54A-B, a second recipient record 52B of the plurality of recipient records 52A-B, a second notification instruction 54B of the plurality of notification instructions 54A-B, and a decedent record 50A. The first recipient record 52A is associated with a client and includes a first recipient interface address 53A of a plurality of recipient addresses 53A-B. The first notification instruction 54A is configured to be sent to the first recipient interface address 53A. The second recipient record 52B is associated with the client and includes a second recipient interface address 53B of the plurality of recipient addresses 53A-B. The second notification instruction 54B is configured to be sent to the second recipient interface address 53B. The decedent record 50A is configured to reference the plurality of notification instructions 54A-B. The all companies deceased notification system also includes notifier programming 14B in the notifier memory 23. Execution of the notifier programming 14B by the notifier processor 22 configures the all companies deceased notification system 100 to implement functions. The all companies deceased notification system 100 determines the client has died. The all companies deceased notification system 100 sends the plurality of notification instructions 54A-B to the plurality of recipient interface addresses 53A-B included in the plurality of recipient records 52A-B associated with the client.

In some examples, the plurality of notification instructions 54A-B can be all sent to the plurality of recipient interface addresses 53A-B included in the plurality of recipient records 52A-B associated with the client in response to a single physical interaction at the notifier interface 21. Alternatively or additionally, the plurality of notification instructions 54A-B can all be sent to the plurality of recipient interface addresses 53A-B included in the plurality of recipient records 52A-B associated with the client in response to the determination that the client has died and zero physical interactions at the notifier interface 21.

FIG. 2 is a flowchart depicting the all companies deceased notification process 200 or protocol. All companies deceased notification process 200 prepares the clients notification records before the death of the client, determines the death of the client, and sends the clients notifications after the client's death.

In block 205, all companies deceased notification process 200 includes creating a decedent record 50A, the decedent record 50A associated with a client. In block 210, all companies deceased notification process 200 includes creating a recipient record 52A, the recipient record 52A referencing the decedent record 50A and including a recipient interface address 53A. In block 215, all companies deceased notification process 200 includes creating a notification instruction 54A, the notification instruction 54A referencing the recipient record 52A and configured to be sent to the recipient interface address 53A. In block 220, all companies deceased notification process 200 includes determining the client has died. All companies deceased notification process 200 has at least two sub-blocks to facilitate determining the client has died. In block 221, all companies deceased notification process 200 includes comparing death certificate information from a death certificate to client information associated with the client. Alternatively or additionally, in block 222, all companies deceased notification process 200 includes comparing a recorded identifier in an identifier death database 15 to a client identifier associated with the client. These identifiers may be, for example, social security numbers. Regardless of whether block 221, block 222, or another method for determining the client has died (such as an attestation by the executor), in block 225 all companies deceased notification process 200 includes sending the notification instruction 54A to the recipient interface address 53A included in the recipient record 52 associated with the client. Alternatively or additionally, in block 230 all companies deceased notification process 200 can include sending a plurality of notification instructions 54A-B to a plurality of recipient interface addresses 53A-B included in a plurality of recipient records 52A-B associated with the client. The plurality of notification instructions 54A-B to the plurality of recipient interface addresses 53A-B included in the plurality of recipient records 52A-B associated with the client can all be sent in response to a single physical interaction. Alternatively or additionally, the plurality of notification instructions 54A-B to the plurality of recipient interface addresses 53A-B included in the plurality of recipient records 52A-B associated with the client can all be sent in response to the determination that the client has died.

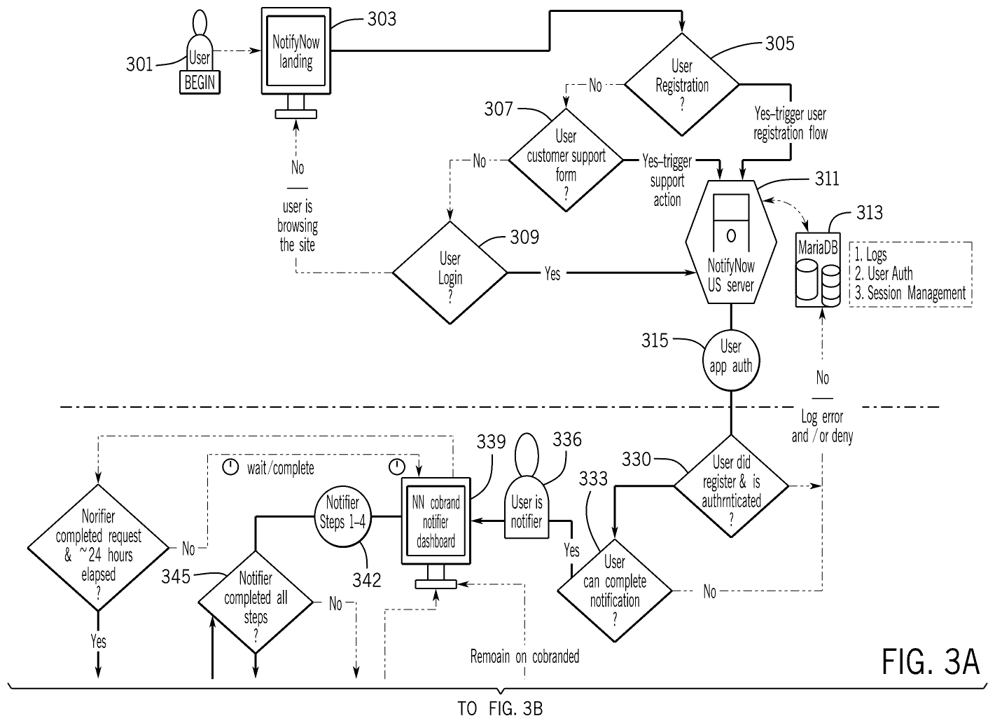

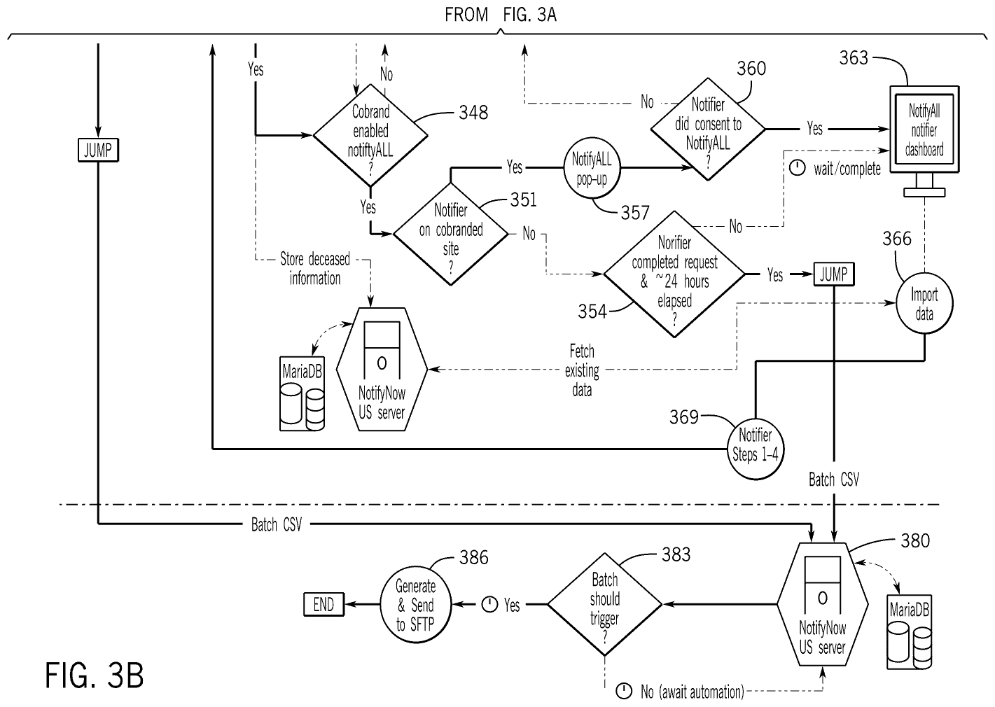

FIGS. 3A and 3B are flowcharts depicting a detailed implementation of a portion of the all companies deceased notification process 200. At block 301, the user is the executor described above. At block 303, the user accesses notifier interface 21. At block 305, it is ascertained whether the user or executor is registered: registration can be understood as having a client with decedent records 50A in the notifier device 20. If not, and if in block 307 the user is not using the customer support form, the user is directed to log in at block 309. Should they not log in, the user is returned to block 303. If the user has a customer support issue, or they log in, they move to block 311, which authenticates the user as an executor, or opens a communication link to a customer support action. Block 311 stores logs, user authorizations, and session management in a database at block 313. Once authenticated is attempted in block 315, in block 330 it is determined whether the user both is registered and authenticated. If not, the failure is logged in block 313, and the user is ejected, likely to block 303.

If the user is both registered and authenticated, the success is logged in block 313, and in block 333 it is determined whether the user is a notifier (e.g., an executor). If the user is not a notifier (e.g., a client), the user is ejected, as this section of the all companies deceased notification process 200 implement is concerned with post-death notification, not pre-death configuration. If the user is a notifier in block 336, the user is granted access to the notifier dashboard in block 339. From this dashboard, the notifier can determine whether the client has died (e.g., block 220 of FIG. 2), and then start the process of sending notification instruction 54A (e.g., block 225 of FIG. 2).

All companies deceased notification process 200 then sends the notification instruction 54A in block 342. Once that is complete in block 345 and logged in block 346 along with decedent information, it is determined whether additional bulk notifications are enabled in block 348. If not, the user is returned to block 339. Otherwise it is determined whether the notifier is using access to send bulk notification in block 351.

If the notifier is using access to send bulk notifications, in block 357 a pop-up brings this fact to the notifier's attention. If the notifier is determined to have consented to use bulk notification in block 360, in block 363 the notifier interface 21 is changed to allow for bulk sending of notification instructions 54A-B. If not, the notifier interface 21 stays or returns to block 339.

In block 366, bulk data is imported, either from the notifier entering additional recipient records 52B with respective recipient interface addresses 53B and notification instructions 54B, or from fetching existing recipient records 52B from the decedent record 50A stored at block 346. In block 369, similarly to block 342, notification instructions not yet sent 54A-B are processed. Block 345 is returned to, and if the notifier 351 is no longer using access to send or modify bulk notification (e.g., the user has logged out), in block 354 it is determined whether bulk notification instructions 54A-B were confirmed for sending and twenty-four hours have elapsed. If so, in block 380 bulk notification instructions 54A-B are added to a batch comma-separated value (CSV) file for batch sending at block 380. This is similar to block 340, where it is determined whether individual notification instruction 54A was confirmed for sending and twenty-four hours have elapsed. If so, in block 380 individual notification instruction 54A is added to a batch comma-separated value (CSV) file for batch sending at block 380. Block 380 removes duplicate records from the CSV file to avoid multiple reports of the same notification instruction 54A. In block 383, it is determined whether the batch should be triggered for sending. If not, the process loops back to block 380 until it is time to trigger the batch. Once triggered, the notification instructions 54A-B are generated in block 386, which can include any final or all formatting, and can include appending recipient interface addresses 53A-B if not yet included, and sent via secure file transfer protocol (SFTP) to their respective recipient devices 30A-B at their recipient interface addresses 53A-B.

The instructions, programming, or application(s) may be software or firmware used to implement the device functions associated with the device such as the scanners, printers and PCs described throughout this description. Program aspects of the technology may be thought of as “products” or “articles of manufacture” typically in the form of executable code or process instructions and/or associated data that is stored on or embodied in a type of machine or processor readable medium (e.g., transitory or non-transitory), such as a memory of a computer used to download or otherwise install such programming into the source/destination PC and/or source/destination printer.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

It should be understood that all of the figures as shown herein depict only certain elements of an exemplary system, and other systems and methods may also be used. Furthermore, even the exemplary systems may comprise additional components not expressly depicted or explained, as will be understood by those of skill in the art. Accordingly, some embodiments may include additional elements not depicted in the figures or discussed herein and/or may omit elements depicted and/or discussed that are not essential for that embodiment. In still other embodiments, elements with similar function may substitute for elements depicted and discussed herein.

Any of the steps or functionality of the system and method for converting graphic files for printing can be embodied in programming or one more applications as described previously. According to some embodiments, “function,” “functions,” “application,” “applications,” “instruction,” “instructions,” or “programming” are program(s) that execute functions defined in the programs. Various programming languages may be employed to create one or more of the applications, structured in a variety of manners, such as object-oriented programming languages (e.g., Objective-C, Java, or C++), procedural programming languages (e.g., C or assembly language), or firmware. In a specific example, a third party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating systems. In this example, the third party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

The terms “decedent notification system” may be used interchangeably with “all companies deceased notification system” and no distinction between the two terms should be inferred unless otherwise explicitly indicated. Further, the terms “all companies deceased notification process” may be used interchangeably with “decedent notification protocol” and no distinction between the two terms should be inferred unless otherwise explicitly indicated.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g. approximate, substantially or about), may vary by as much as ±10% from the recited amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected may lie in less than all features of any single disclosed example. Hence, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. An all companies deceased notification system, comprising:
a notifier interface;
a notifier processor, coupled to the notifier interface;
a notifier memory coupled to the notifier processor, the notifier memory configured to include:
a recipient record, the recipient record associated with a client and including a recipient interface address,
a notification instruction, the notification instruction configured to be sent to the recipient interface address, and
a decedent record, the decedent record referencing the notification instruction; and
notifier programming in the notifier memory, wherein execution of the notifier programming by the notifier processor configures the all companies deceased notification system to implement functions, including functions to:
determine the client has died;
send the notification instruction to the recipient interface address included in the recipient record associated with the client.

2. The all companies deceased notification system of claim 1, further comprising a recipient interface, wherein the sent notification instruction is displayed on the recipient interface.

3. The all companies deceased notification system of claim 2, further comprising:
a notifier network interface, coupled to the notifier interface and configured to communicate over a network; and
a recipient network interface, coupled to the recipient interface and configured to communicate over the network;
wherein:
the notification instruction sent to the recipient interface address is sent from the notifier network interface to the recipient network interface via the network.

4. The all companies deceased notification system of claim 3, wherein the recipient interface is configured to receive digital signals and analog signals, and the notification instruction sent to the recipient interface address from the notifier network interface is sent only as a digital signal.

5. The all companies deceased notification system of claim 3, wherein the recipient interface is configured to receive digital signals in a non-human-readable format, and to receive analog signals or digital signals in a human-readable format, and the notification instruction sent to the recipient interface address from the notifier network interface is sent only as a digital signal in a non-human readable format.

6. The all companies deceased notification system of claim 1, wherein the function to determine the client has died further includes comparing death certificate information from a death certificate to client information associated with the client.

7. The all companies deceased notification system of claim 1, wherein the function to determine the client has died further includes comparing a recorded identifier in an identifier death database to a client identifier associated with the client.

8. The all companies deceased notification system of claim 7, wherein the identifier death database is included within the notifier memory.

9. The all companies deceased notification system of claim 1, further comprising:
a client interface;
a client processor, coupled to the client interface;
a client memory coupled to the client processor; and
client programming in the client memory, wherein execution of the client programming by the client processor configures the all companies deceased notification system to implement functions, including functions to:
create or modify the notification instruction.

10. The all companies deceased notification system of claim 1, wherein the notification instruction includes credentials associated with the client at a recipient associated with the recipient interface address.

11. The all companies deceased notification system of claim 1, wherein:
the recipient interface address is associated with a recipient;
the client is associated with a client account held by the recipient;
the notification instruction includes a credentialing prerogative, the credentialing prerogative instructing the recipient to associate the client account to a third-party credential.

12. An all companies deceased notification system, comprising:
a notifier interface;
a notifier processor, coupled to the notifier interface;
a notifier memory coupled to the notifier processor, the memory configured to include:
a first recipient record of a plurality of recipient records, the first recipient record associated with a client and including a first recipient interface address of a plurality of recipient addresses,
a first notification instruction of a plurality of notification instructions, the first notification instruction configured to be sent to the first recipient interface address,
a second recipient record of the plurality of notification instructions, the second recipient record associated with the client and including a second recipient interface address of the plurality of recipient addresses,
a second notification instruction of the plurality of notification instructions, the second notification instruction configured to be sent to the second recipient interface address, and
a decedent record, the decedent record configured to reference the plurality of notification instructions; and
notifier programming in the notifier memory, wherein execution of the notifier programming by the notifier processor configures the all companies deceased notification system to implement functions, including functions to:
determine the client has died;
send the plurality of notification instructions to the plurality of recipient interface addresses included in the plurality of recipient records associated with the client.

13. The all companies deceased notification system of claim 12, wherein the plurality of notification instructions is all sent to the plurality of recipient interface addresses included in the plurality of recipient records associated with the client in response to a single physical interaction at the notifier interface.

14. The all companies deceased notification system of claim 12, wherein the plurality of notification instructions is all sent to the plurality of recipient interface addresses included in the plurality of recipient records associated with the client in response to the determination that the client has died and zero physical interactions at the notifier interface.

15. A method, comprising:
creating a decedent record, the decedent record associated with a client;
creating a recipient record, the recipient record referencing the decedent record and including a recipient interface address;
creating a notification instruction, the notification instruction referencing the recipient record and configured to be sent to the recipient interface address;
determining the client has died; and
sending the notification instruction to the recipient interface address included in the recipient record associated with the client.

16. The method of claim 15, wherein determining the client has died further includes comparing death certificate information from a death certificate to client information associated with the client.

17. The method of claim 15, wherein determining the client has died further includes comparing a recorded identifier in an identifier death database to a client identifier associated with the client.

18. The method of claim 15, further comprising sending a plurality of notification instructions to a plurality of recipient interface addresses included in a plurality of recipient records associated with the client.

19. The method of claim 18, wherein the plurality of notification instructions to the plurality of recipient interface addresses included in the plurality of recipient records associated with the client are all sent in response to a single physical interaction.

20. The method of claim 18, wherein the plurality of notification instructions to the plurality of recipient interface addresses included in the plurality of recipient records associated with the client are all sent in response to the determination that the client has died.
